(19) United States
(12) Patent Application Publication
(10) Pub. No.: US 2003/0191194 A1
(43) Pub. Date: Oct. 9, 2003

(54) Oil/water viscoelastic compositions and method for preparing the same

(76) Inventor: Ramesh Varadaraj, Flemington, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 10/391,432

(22) Filed: Mar. 18, 2003

Related U.S. Application Data
(60) Provisional application No. 60/371,168, filed on Apr. 9, 2002.

(51) Int. Cl. B01F 17/00; C09D 195/00; B01F 3/08

(52) U.S. Cl. 516/52

(57) ABSTRACT

The invention is directed to viscoelastic compositions comprising oil and flocculated water droplets and method for preparing such compositions.

This is a Non-Provisional application of Provisional U.S. Serial No. 60/371,168 filed Apr. 9, 2002.

### FIELD OF THE INVENTION

The invention is directed to viscoelastic compositions comprising oil and flocculated water droplets and a method for preparing such compositions.

### BACKGROUND OF THE INVENTION

Oil based and water based viscoelastic compositions have a variety of uses in improved oil recovery and lubrication technologies. Viscoelastic compositions normally comprise synthetic or naturally occurring polymers or mixtures of such polymers solubilized in oil or in water. Use of polymers to impart viscoelastic properties to water or oil is known in the art. Primary limitations of this approach are polymer compatibility with the oil or water and cost of the polymer additive. Thus, viscoelastic compositions wherein a synthetic or natural occurring polymer is not one of the components and methods of economically preparing such viscoelastic compositions are needed.

### SUMMARY OF THE INVENTION

The invention includes a viscoelastic composition comprising an oil having flocculated water droplets dispersed in said oil.

The invention also includes a method to prepare a viscoelastic composition comprising, forming a water-in-oil emulsion, and then aggregating the water in the emulsion into flocs.

The invention further includes an improved method for recovering hydrocarbons form a subterranean formation comprising:

injecting into the subterranean formation a viscoelastic composition comprising a hydrocarbon oil having flocculated water droplets dispersed in said oil; and recovering hydrocarbons from said subterranean formation.

### BRIEF DESCRIPTION OF THE FIGURES

FIG. 1 depicts the elastic modulus G′ (Y-axis) versus shear rate frequency (X-axis) for viscoelastic compositions made from six different crude oils at 60° C.

FIG. 2 depicts viscous modulus G″ (Y-axis ) versus shear rate frequency (X-axis) for viscoelastic compositions made from six different crude oils at 60° C.

### DETAILED DESCRIPTION OF THE INVENTION

The oil component of the viscoelastic composition of the invention is any natural or synthetic oil, including but not limited to crude oil, crude oil distillates, oil blends, chemically treated oils, resids, thermally treated oils, bitumen and mixtures thereof. The total oil content of the composition can vary in the range of about 70 wt % to about 30 wt % based on the total weight of the viscoelastic composition. The preferred range is 65 wt % to 45 wt % based on the total weight of the viscoelastic composition.

Preferably, the oil contains at least about 0.1 wt % to about 40 wt %, more preferably at least about 0.1 to about 15 wt % of polar hydrocarbons based on the weight of the oil in the viscoelastic composition. Non-limiting examples of polar hydrocarbons present in crude oils are asphaltenes, naphthenic acids, basic nitrogen containing organic compounds and metalloporphyrins. In instances where the oil does not contain the requisite amounts of polar hydrocarbons, polar hydrocarbons such as those extracted from crude oils may be added to the oil.

The water component of the viscoelastic composition need not be salt free and may contain salts such as halogens, sulfates or carbonates of Group I and Group II of the Periodic Table of Elements. Up to 20 wt % salts; based on the weight of water in the viscoelastic composition, can be present in the water. The total water content of the viscoelastic composition can vary in the range of 30 wt % to 70 wt % based on the total weight of the viscoelastic composition.

A method to prepare the viscoelastic composition includes the first step of adding water to oil and mixing sufficiently to form a stable water-in-oil emulsion. Mixing may be performed using any mixing technique, for example, mixing using static mixers or paddle mixers. The water and oil are preferably mixed to form an emulsion having dispersed water droplets in the size range of 0.1 to 50 microns diameter. A water-in-oil emulsion can be characterized by observation of a sample of the emulsion under an optical or electron microscope. If an electron microscope is used it is preferred to use the freeze fracture technique.

Optionally, solids are added to the oil prior to addition of water and mixing to form the water-in-oil emulsion. The solids may be selected from a variety of materials including inorganic and organic solids. For example, inorganic solids may include fumed silica, sold under the trade name of Aerosil 130 by DeGussa Company, bentonite clays, divided or delaminated bentonite clay gel, kaolinite clays, and mixtures thereof. The organic solids may include for example carbanaceous solids such as soot and coke fines or mixtures thereof. The solids, if spherical are preferably in the size range of about 20 microns or less in diameter, more preferably less than 10 micron, even more preferably less than 5 microns, and most preferably about 2 micron or less, more specifically 100 nanometers or less. The solids, if non-spherical or spherical, preferably have a total surface area of about 1500 square microns or less. The preferred treat rate for the solids is about 0.05 to about 5.0 wt %, based on the weight of the oil, more preferably, 0.05 to 2.0 wt %. The preferred solids are clays, specifically montmorillonite clays such as bentonite. It is preferable that the solids remain dispersed or undissolved in the oil. It is also preferred that the solid particles are amphiphilic solids. The amphiphilicity of the solids can be determined by water wettability methods known in the art.

If bentonite is used as the solid, it is used in divided or delaminated form as a gel. When divided bentonite gel is used, the amount of gel added to the oil can vary in the range of about 5 to about 15% of gel based on the weight of the oil. The weight of bentonite clay solids in the gel can vary from 1 to 10 wt % based on the weight of the water. Bentonite clay gel can easily be prepared by delamination or peptization methods known in the art. An Introduction to Clay Colloid Chemistry by H. van Olphen second Edition John Wiley & Sons provides a description of peptizing and delamination methods practiced in the art. Bentonite clay gel can be treated prior to addition to the oil. The treatment comprises an air oxidation process wherein equal amounts of bentonite clay gel and crude oil are mixed and the mixture heated to 150 to 185° C. in the presence of a stream of air. The water and hydrocarbons that boil below 150 to 185° C. distill off from the reactor and are collected. The product that remains in the reactor is an oil wetted treated bentonite clay.

The second step of the method to prepare the viscoelastic composition is aggregating the dispersed droplets of water in the water-in-oil emulsion into flocs.

As is known, flocculation is the phenomena of aggregating a substance into a broad mass of particles or flocs. In the case of the water-in-oil emulsion the dispersed water droplets are aggregated into flocs. In a flocculated state, when water droplets are aggregated and do not coalesce stable flocs result and subsequently stable viscoelastic compositions. Applicant believes the microstructure of the viscoelastic composition of the present invention can be described as one where flocculated water droplets are distributed in an oil continuous medium. This composition is in contrast to a water-in-oil emulsion composition wherein individual water droplets are dispersed in an oil continuous medium and the droplets are not flocculated.

The method of aggregating the water droplets of the water-in-oil emulsion is conducted under conditions sufficient to aggregate the dispersed water droplets without causing coalescence. For example, centrifugation is one method to effect flocculation of the dispersed water droplets. Centrifugation of the water-in-oil emulsion can be conducted between 500 g to 3000 g at a temperature between 15° C. and 80° C. from 2 minutes to 6 hours. Other methods of flocculation like hydrocyclone treatment, electrostatic treatment and combinations thereof are within the scope of the invention. Broadly stated any method that aggregates the dispersed droplets without coalescence are utilizable herein. Centrifugation is a preferred means to aggregate the droplets. Droplet aggregation or flocculation can be detected by observation under an optical microscope and is a customary practice for one of ordinary skill in the art.

Flocs of water droplets resulting in flocs of sizes between 4 microns to 400 microns diameter are preferred. Flocs of water droplets can be spherical, oblate or irregular shaped. In describing the size of the floc its shape is approximated to a sphere that would enclose the floc. The droplet sizes of the individual water droplets that constitute the floc can range between 0.1 to 50 microns diameter. While not wishing to be bound by the theory of the origin of flocculation or aggregation, the hydrophobic interaction between the polar hydrocarbon films that form the stabilizing film around the dispersed droplets is one source of droplet aggregation. Presence of amphiphilic solids can further enhance the hydrophobic interaction causing droplet flocculation. The polar hydrocarbons and solids form a protective barrier to coalescence thus rendering the composition unique. The flocculation phenomenon exhibited by the water droplets covered with a molecular sheath of hydrocarbon polars and solids is unique and unexpected.

Viscoelastic compositions comprising a hydrocarbon oil having flocculated water droplets dispersed in the oil exhibit a lower viscosity than the corresponding water-in-oil emulsions. This feature renders the viscoelastic composition useful as a pusher fluid in crude oil recovery processes.

### EXAMPLES

The following non-limiting examples illustrate the invention.

### Example 1

Water-in-crude oil emulsions were first prepared with six crude oils: Talco, Tulare, Kome, Hoosier, Hamaca and Miandoum. These crude oils posses between 0.1 to 15 wt % polar hydrocarbon, i.e., asphaltenes, naphthenic acids and basic nitrogen compounds. The corresponding water-in-crude oil emulsion was made at a ratio of 60 wt % water:40 wt % crude oil.

To 40 g of the crude oil were added 60 g of water and mixed. A Silverson mixer supplied by Silverson Machines, Inc. East Longmeadow, Mass. was used for mixing. Mixing was conducted between 25° C. and 80° C. at 10,000 rpm for a time required to disperse all the water into the oil. Water was added to the crude oil in aliquots spread over 5 additions. Each emulsion was then centrifuged for 1 hour at 2000 G using a DYNAC II centrifuge. The resulting centrifuged product represents the viscoelastic composition of the invention.

The centrifuged emulsions were observed under an optical microscope before and after centrifugation. Prior to centrifugation dispersed water droplets in the size range of 1 to 10 microns were observed with no evidence of flocculation. After centrifugation flocculated droplets were observed in the size range of 4 to 400 microns.

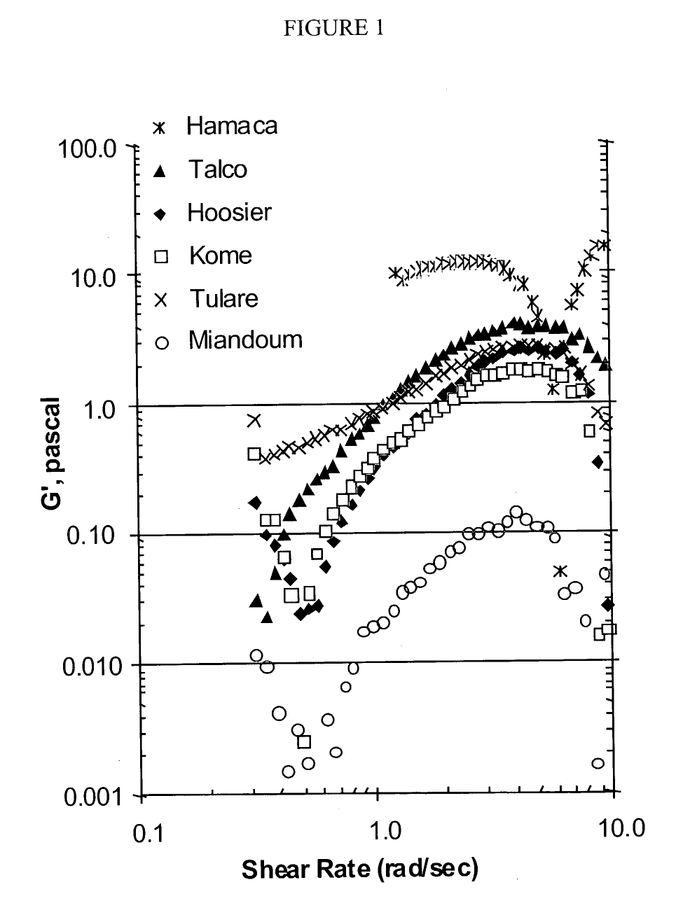

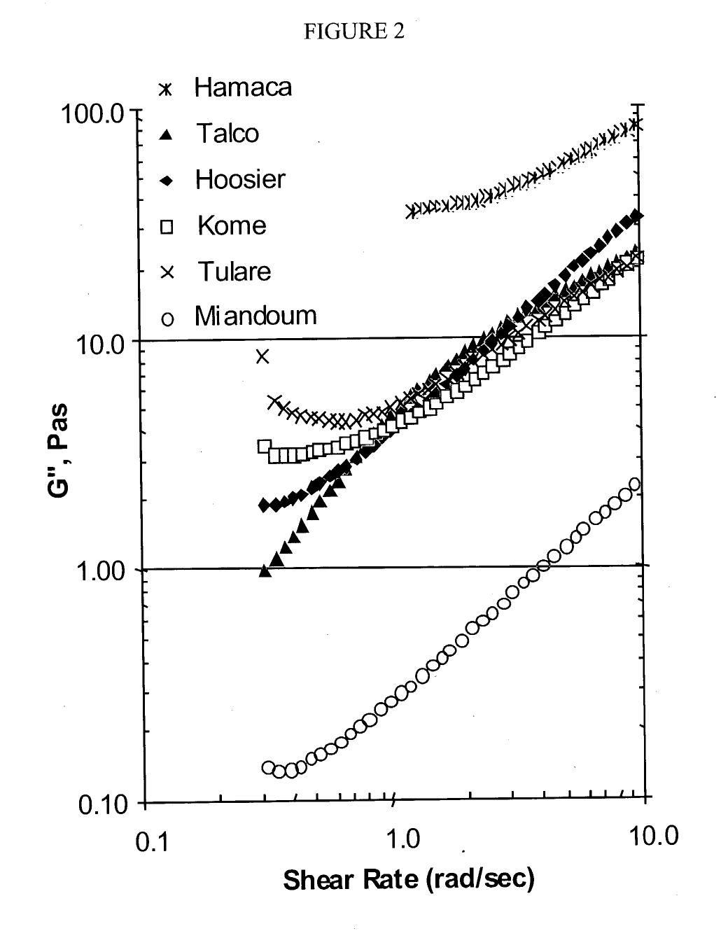

Viscoelastic properties of the centrifuged emulsions were measured using a Haake Rheometer in the oscillatory mode of operation. Viscoelastic properties are generally expressed in the art terms of loss modulus (G″ and storage modulus (G′). G″ and G′ represent the viscous and elastic components of the response of the composition to an applied strain. G′ and G″ as a function of frequency sweep were determined for a fixed sinusoidal oscillation in the 40 to 80° C. temperature range. G′ and G″ at 60° C. for six crude oil viscoelastic compositions are given in FIGS. 1 and 2 respectively. All the compositions show strong viscoelastic behavior as evidenced by the existence of the viscous and elastic modulus. The elastic modulus G′ is non-linear and exhibits a unique fracture phenomenon at a frequency of oscillation of about 10 radian/sec. The fracture phenomenon exhibited by the viscoelastic compositions of the invention is not observed with viscoelastic compositions known in the art, for example, those made with water and water soluble polymer. Further, the elastic modulus and viscous modulus of the viscoelastic compositions vary as a function of the type of oil.

The viscoelastic compositions were observed under the microscope after subjecting it to the shear oscillation in the viscometer. Flocs of water droplets were observed and the size distribution of the flocs was unchanged. This is an indication that once formed the viscoelastic compositions are stable to shear and do not alter their microstructure, i.e., flocculated water droplets in an oil continuous medium. Further, the viscous and elastic profiles were repeatable even after five cycles of shearing.

Viscoelastic properties of the water-in-oil emulsions prior to centrifugation were measured using the Haake Rheometer in the oscillatory mode of operation. In all these samples the viscosity of the water-in-oil emulsions were about 6 to 10 times higher than the corresponding viscoelastic compositions obtained after centrifugation. Further, the elastic component (G′) was about an order of magnitude lower. These comparative experiments illustrate the criticality of the flocculated water droplet microstructure in the viscoelastic composition.

### Example 2

Water-in-crude oil emulsions were first prepared with six crude oils: Talco, Tulare, Kome, Hoosier, Hamaca and Miandoum as described in Example 1 with the inclusion of solids as additional components. The corresponding water-in-crude oil emulsion was made at a ratio of 60 wt % water:40 wt % crude oil and having 0.05 wt % Aerosil R-972 silica, obtained from Degussa Company, as the amphiphilic solids. Samples were centrifuged as described above to prepare the corresponding viscoelastic compositions. Microscopy and viscoelastic measurements were made. Trends in results were similar to those obtained in Example 1.

What is claimed is:

1. A viscoelastic composition comprising an oil having flocculated water droplets dispersed in said oil.

2. The viscoelastic composition of claim 1 wherein the oil includes at least 0.1 wt % of polar hydrocarbons based on the weight of the oil.

3. The viscoelastic composition of claim 1 wherein the composition contains about 70 to 30 wt % oil based on the weight of the viscoelastic composition.

4. The viscoelastic composition of claim 1 wherein the water is in the range of about 70 to 30 wt % based on the weight of the viscoelastic composition.

5. The viscoelastic composition of claim 1 wherein the flocculated water droplets range in size from about 4 to about 400 microns diameter.

6. The viscoelastic composition of claim 1 wherein said oil is selected from the group consisting of crude oil, crude oil distillate, thermally treated oil, chemically treated oil, residuum of crude oil distillation, bitumen, or mixtures thereof.

7. The viscoelastic composition of claim 1 wherein said flocculated water comprises salts of halogens, sulfates or carbonates of Group I and Group II elements of The Periodic Table of Elements and mixtures thereof.

8. The viscoelastic composition of claim 7 wherein the total weight of said salts is up to 20 wt % based on the weight of water.

9. The viscoelastic composition of claim 1 further comprising solids in the range of about 0.05 to 5 wt % based on the weight of the oil.

10. The viscoelastic composition of claim 9 wherein said solids are selected from the group consisting of fumed silica, bentonite clays, divided bentonite clay gel, oil wetted treated bentonite clay, kaolinite clays, coke fines, soot and mixtures thereof.

11. The viscoelastic composition of claim 10 wherein the divided bentonite clay gel comprises about 1 to about 10 wt % clay solids and about 90 to about 99 wt % water.

12. A method to prepare a viscoelastic composition comprising:
(a) forming a water-in-oil emulsion, and then
(b) aggregating the water into flocs.

13. The method of claim 12 wherein said water-in-oil emulsion is formed by adding water to oil and mixing.

14. The method of claim 12 wherein said aggregation is conducted without coalescing said water.

15. The method of claim 12 wherein the aggregation is sufficient to form flocs in the size range of about 4 microns to about 400 microns diameter.

16. The method of claim 12 wherein said aggregation is by centrifuging the water-in-oil emulsion between 500 G to 3000 G at a temperature between 15° C. and 80° C. for 2 minutes to 6 hours.

17. The method of claim 12 further comprising adding solids to the oil prior to formation of a water-in-oil emulsion.

18. In a method for recovering hydrocarbons from a subterranean formation comprising injecting a viscoelastic fluid into said subterranean formation, the improvement in the recovery method comprising:
injecting into a subterranean formation a viscoelastic composition comprising a hydrocarbon oil having flocculated water droplets dispersed in said oil; and recovering hydrocarbons from said subterranean formation.

19. The method of claim 18 wherein the hydrocarbon oil includes at least 0.1 wt % of polar hydrocarbons based on the weight of the hydrocarbon oil.

20. The method of claim 18 wherein the hydrocarbon oil is in the range of about 70 to 30 wt % based on the weight of the viscoelastic composition.

21. The method of claim 18 wherein the water is in the range of about 70 to 30 wt % based on the weight of the viscoelastic composition.

22. The method of claim 18 wherein the flocculated water droplets range in size from about 4 to about 400 microns diameter.

23. The method of claim 18 wherein said hydrocarbon oil is selected from the group consisting of crude oil, crude oil distillate, thermally treated oil, chemically treated oil, residuum of crude oil distillation, bitumen, or mixtures thereof.

24. The method of claim 18 wherein said flocculated water comprises salts of halogens, sulfates or carbonates of Group I and Group II elements and mixtures thereof.

25. The method of claim 24 wherein the total weight of said salts is up to 20 wt % based on the weight of water.

26. The method of claim 18 wherein said viscoelastic composition further comprises solids in the range of about 0.05 to 5 wt % based on the weight of said oil.

27. The method of claim 26 wherein said solids are selected from the group consisting of fumed silica, bentonite clays, divided bentonite clay gel, oil wetted treated bentonite clay, kaolinite clays, coke fines, soot and mixtures thereof.

28. The method of claim 27 wherein the divided bentonite clay gel comprises about 1 to about 10 wt % clay solids and about 90 to about 99 wt % water.
